(19) United States
(12) Patent Application Publication
(10) Pub. No.: US 2020/0410493 A1
(43) Pub. Date: Dec. 31, 2020

(54) Computer Implemented System and Method for Cashless and Cardless Transactions

(71) Applicant: Mandar AGASHE, Pune - Maharashtra (IN)

(72) Inventor: Mandar AGASHE, Pune - Maharashtra (IN)

(21) Appl. No.: 16/965,176

(22) PCT Filed: Dec. 27, 2018
(86) PCT No.: PCT/IB2018/060633

§ 371 Date: Jul. 27, 2020

(30) Foreign Application Priority Data
Dec. 27, 2017 (IN) 201723046772

(51) Int. Cl. G06Q 20/40; G06Q 20/42; G06Q 20/38; G06Q 20/10

(52) U.S. Cl. CPC G06Q 20/4014; G06Q 20/102; G06Q 20/385; G06Q 20/42

(57) ABSTRACT

A system of the present disclosure envisages a computer implemented system (200,300) for a cardless and cashless transaction. The system (200, 300) comprises a database vault (218), a customer interface device (202), a transaction server (210) and a merchant device (302). The customer interface device (202) configured to initiate a first vine by calling on a toll free number of a financial institution (208) over a first channel and providing at least one of a merchant ID and a transaction amount. The transaction server (210) of the financial institution (208) configured to generate a time bound OTP in response to the call and communicate over the first channel the same to the customer interface device (202), wherein the time bound OTP includes encoded information. The merchant device (302) configured to transmit the received time bound OTP to an authorizing interface (216) of the transaction server (210) for authorizing the transaction.

### FIELD

The present disclosure relates to the field of internet commerce, and in particular relates to a system for performing financial transactions for making payments and withdrawal of cash.

### DEFINITIONS OF TERMS USED IN THE SPECIFICATION

The expression ‘user’ used hereinafter in the specification refers to, but is not limited to, a customer, payer, merchant, and payee.

The expression ‘customer interface device’ and/or ‘merchant interface device’ used hereinafter in the specification refers to, but is not limited to, mobile phones, a laptop, a tablet, a desktop, an iPad, a PDA, a notebook, a net book, and a tablet.

The expression ‘merchant’ used hereinafter in the specification refers to, but is not limited to, an e-commerce website, a merchant Point-of-Sale (POS), and an Automated-Teller-Machine (ATM) for withdrawing and/or depositing cash.

The expression ‘financial institution’ used hereinafter in the specification refers to, but is not limited to, a bank, a financial repository, a vaults, a credit union, an investment firm, an account repository, and an online money transfer financial organization.

The expression ‘financial account’ used hereinafter in the specification refers to, but is not limited to, a bank account, a financial repository account, a vault account, a credit union account, an investment firm account, a repository account, a PayPal account, and a Authorize.net account.

The expression ‘payment network's authentication application’ used hereinafter in the specification refers to, but is not limited to, a Visa's 3D Secure.

The expression ‘vine’ used hereinafter in the specification refers to, but is not limited to, a pathway or a way for conducting a transaction.

The expression ‘device identification indicia’ used hereinafter in the specification refers to, but is not limited to, an International Mobile Station Equipment Identity (IMEI), an International Mobile Subscriber Identity (IMSI), a digital certificate, a mobile number, an encryption key and a combination thereof.

The above definitions are in addition to those expressed in the art.

### BACKGROUND

Using cash as a mode of transactions has been a popular method practiced worldwide, since centuries. Typically, exchanging cash in return for goods and commodities has been a popular way of procuring goods and commodities. However, one of the shortcomings of exchanging cash in return for goods and commodities is that the exchanged cash needs to be safeguarded against robbery attempts. Further, carrying and depositing a large amount of money has always been a cumbersome task.

A person typically performs numerous transactions to meet his/her daily requirements for example, selling/purchasing of goods/commodities. One of the major shortcomings of preferring cash transactions is that it involves high level of risks as one need to safeguard the money for security reasons. Further, carrying cash in bulk also increases the possibilities of occurrences of undesirable incidents such as robbery attempts and attempts at theft.

Attempts have been made by the financial institutions to obviate the need of carrying large amount of cash. The financial institutions, therefore introduced cheques for making payments in bulk. Cheques are paper-based form of making payment(s).

Cheques to a certain extent have reduced people's dependency on hard cash and have effectively acted as a secured mode of performing transactions. Typically, in cheque based transactions, a payer is required to present a cheque to the payee, who in turn submits the cheque to a financial institution with whom he/she is associated. Once the cheque is received by the financial institution, it usually takes at least three working days for a cheque to get clearance from the financial institution. Cheques are safer than cash and better alternative for making large amount payments. However, major shortcomings of cheques are that it takes a lot of time for clearance, or the cheque may get rejected, or the financial institution can refuse to accept a cheque with an error and the like.

Internet has made processing of monetary transactions exponentially faster than ever. With the increasing number of internet users, service providers are targeting to provide more and more services over the Internet. The major revolution in the field of cashless transactions is brought in by the introduction of Internet e-commerce. Internet e-commerce has introduced card based transactions such as debit card, credit card, which can be used to make electronic payments. If a person has run out of hard cash, he may still use his credit card or debit card to make transactions. Typically, these electronic cards are plastic cards, issued by financial institutions, enabling the user to carry out monetary transactions without carrying hard cash himself.

Transactions facilitated by the aforementioned cards also provide remote access to the user's financial account(s) whenever or wherever required. The benefits of using cards for transactions are guaranteed payments, completing large transactions in negligible time, can be used for mail order or online purchases. E-transactions enable users to make payments sitting at home(s) or office(s). The drawbacks related to card transaction are that it takes more than three days for the money to be received by the payee; a fee must be paid to the financial institution if a credit card is used and in some cases a fee to be paid to the payee if a debit card is used. Credit cards involve high interest rates so it becomes a very expensive way of borrowing money from the financial institution, if debts are not cleared on time. One of the major drawbacks conferred by the e-transaction cards is that the users still need to carry their e-transaction cards. If an undesirable incident, such as loss of the card occurs, the user may be left with zero balance in his financial account before a complaint can be lodged in the associated financial account.

A user may wish to pay money to another user for varied reasons. With the growth and emergence of new technologies internet e-commerce took one more leap and introduced the concept of direct online payment such as net banking, PayPal, Authorize.net and the like. Further to the aforementioned direct online payment procedures, the user is able to make online payments through handheld devices and can also store their account details on their handheld device(s) by a password protected methodology.

In recent times a growing number of thefts and fraud activities are being noticed that have involved misuse of both plastic money as well as online financial account information. A majority of these incidents have involved hacking of user online accounts or electronic devices used by the user for carrying out online transactions, and then misusing the hacked information specific to the user for carrying out a forging activity(s).

E-commerce merchants, traditional retails and other businesses struggles to protect the customer financial details such bank accounts, card details and the like entrusted with them. In many times, the challenge is made more difficult by the fact that the data is duplicated across multiple systems, applications and databases where customer's financial details are stored unprotected.

The total cost of fraudulent transactions understates the true cost of fraud because it does not take into account significant hidden costs such as stakeholders' investments in fraud-detection technology, services and expertise which qualify as “profit leaks”. It's also observed that the increase of customer distrust has resulted in slow growth of online transactions, which reduces merchant's online revenues and cuts into the various transaction based fees collected by the stakeholders in the value chain.

The patent application number 57/MUM/2013 discloses a computer implemented system and method for facilitating cardless and cashless transactions, which enables a customer to generate and receive a time bound one-time password (OTP) in a first vine. In a second vine, the customer communicates the OTP received in the first vine to a merchant and/or merchant interface device, wherein the merchant interface device is enabled to transmit the OTP to an authorizing interface. The system and method as disclosed in the patent application number 57/MUM/2013 is easy in use, but it is limited to be used only by those customers and merchants who have user interface device applications i.e. on a customer interface device and a merchant interface device, respectively. Moreover, these applications are required to be installed by the customers or merchants on their respective devices.

Therefore, there is felt a need to provide a system that limits the aforementioned drawbacks.

### OBJECTS

Some of the objects of the system of the present disclosure, which at least one embodiment herein satisfies, are as follows:

An object of the present disclosure is to provide a computer implemented system for cashless and cardless transactions.

An object of the present disclosure is to provide a computer implemented system for cashless and cardless transactions that does not reveal user's identity.

Another object of the present disclosure is to provide a computer implemented system for cashless and cardless transactions that withdraw cash from ATM machine without using a financial card.

Still another object of the present disclosure is to provide a computer implemented system for cashless and cardless transactions that enables a user to deposit cash into an ATM machine.

Yet another object of the present disclosure is to provide a computer implemented system for securing cashless and cardless transactions that does not require user signatures for performing monetary transactions.

An object of the present disclosure is to provide a computer implemented system for securing cashless and cardless transactions that facilitates biometric features for performing high value transactions.

Another object of the present disclosure is to provide a computer implemented system for securing cashless and cardless transactions that is reliable.

Yet another object of the present disclosure is to provide a computer implemented system for securing cashless and cardless transactions that is cost effective.

Further, an object of the present disclosure is to provide a computer implemented system for securing cashless and cardless transactions that provides less possibility to misuse the transaction details.

Another object of the present disclosure is to provide a computer implemented system for securing cashless and cardless transactions that prevents the occurrence of fraud transactions in real-time.

Still further, an object of the present disclosure is to provide a computer implemented system for securing cashless and cardless transactions that is user friendly.

Other objects and advantages of the present disclosure will be more apparent from the following description, which is not intended to limit the scope of the present disclosure.

### SUMMARY

The present disclosure envisages a computer implemented system for a cardless and cashless transaction. The system comprises a database vault configured to store registered users details and registered merchants details, a customer interface device, a transaction server and a merchant device. The customer interface device comprises a logging module configured to receive a customer ID and check a registration status in cooperation with the database vault, wherein the customer interface device is configured to initiate a first vine of the transaction by making a call on a toll free number of a financial institution over a first channel via a first communication module and providing at least one of a merchant ID and a transaction amount. The transaction server at a side of the financial institution configured to generate an OTP in response to the call, wherein the transaction server includes an OTP generating means to generate a time bound OTP and communicates the same over the first channel via a second communication module to the customer interface device, wherein the time bound OTP includes encoded information. The merchant device is configured to receive the time bound OTP over a second channel via a third communication module from the customer interface device, wherein the merchant device transmits the time bound OTP to an authorizing interface of the transaction server for authorizing the transaction, wherein the merchant device is configured to initiate a second vine of the transaction.

In an embodiment, the authorizing interface is configured to perform at least the following steps:
decrypt the time bound OTP;
validate the time bound OTP by verifying the encoded information, wherein the authorizing interface cooperates with the customer interface device to validate the time bound OTP; and
at least one of completing the transaction and rejecting the transaction based on a validation of the time bound OTP.

In another embodiment, the first communication channel includes a toll free telephone line.

In yet another embodiment, the transaction server cooperates with the database vault to validate received customer ID and extract details thereof.

In a further embodiment, the encoded information is selected from group consisting of said customer ID, said merchant ID, said transaction amount, a time stamp and any combination thereof.

In a still further embodiment, the transaction server identifies indicia of said customer interface device on the call.

In an implementation, the database vault stores time bound OTP for a pre-defined time for validation purposes.

In an embodiment, a cardless and cashless transaction comprising steps of:
initiating a first vine of a transaction through a customer interface device by providing a customer ID;
calling a transaction server of a financial institution using the customer interface device over a first channel and providing at least one of a merchant ID and a transaction amount;
generating a time bound OTP in response to the call and receiving said time bound OTP over the first channel, wherein the time bound OTP includes encoded information;
communicating the time bound OTP to a merchant interface device over a second channel;
transmitting the time bound OTP to the transaction server for authorizing the transaction, wherein the transaction server cooperates with the customer interface device for the authorizing; and
at least one of completing the transaction and rejecting the transaction based on the authorizing.

In another embodiment, the authorizing of the transmitting includes decrypting the encoded information contained within the time bound OTP.

In yet another embodiment, the decrypting includes checking a timestamp contained within the encoded information to ensure the integrity and confidentiality of the time bound OTP.

In a further embodiment, the generating a time bound OTP includes storing the time bound OTP in a database vault for a pre-defined time for the authorizing purposes.

### BRIEF DESCRIPTION OF THE ACCOMPANYING DRAWINGS

The computer implemented system and method for cardless and cashless transaction of the present disclosure will now be explained in relation to the non-limiting accompanying drawings, in which:

FIG. 1 illustrates a flowchart for registration of the user with the system for performing cardless and cashless transactions, in accordance with the present disclosure.

FIG. 2 illustrates a schematic diagram of a first vine of the system for performing cardless and cashless transactions, in accordance with one embodiment of the present disclosure.

FIG. 3 illustrates a schematic of a second vine of the system for performing cardless and cashless transactions, in accordance with another embodiment of the present disclosure.

FIG. 4 illustrates method steps of performing cardless and cashless transactions, in accordance with an embodiment of the present disclosure.

### LIST OF REFERENCE NUMERALS USED IN THE DESCRIPTION AND DRAWING:

| Reference | |
|---|---|
| Numeral | Reference |
| 200 | A first vine of a system for performing cardless and |
| | cashless transactions |
| 202 | Customer interface device |
| 204 | Logging module |
| 206 | First communication module |
| 208 | Financial institution |
| 210 | Transaction server |
| 212 | OTP generation means |
| 214 | Second communication module |
| 216 | Authorizing interface |
| 218 | Database vault |
| 300 | A second vine of a system for performing cardless and |
| | cashless transactions |
| 302 | Merchant device |
| 304 | Third communication module |
| 306 | User interface |

### DETAILED DESCRIPTION OF THE ACCOMPANYING DRAWINGS

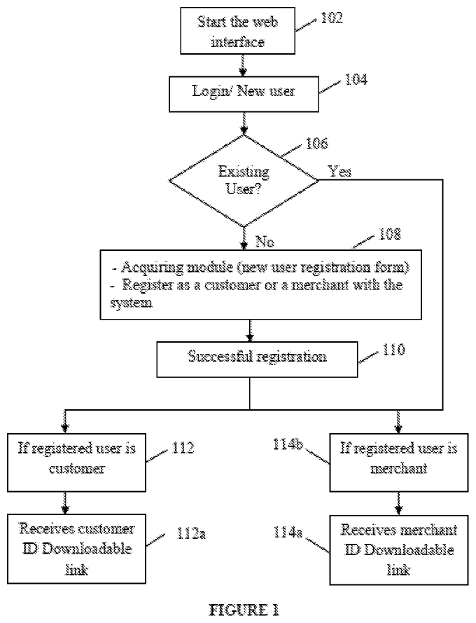

A computer implemented system and method for cashless and cardless transactions of the present disclosure is described with reference to FIGS. 1, 2, 3, and 4 of the accompanying drawing.

Referring to the accompanying drawing, FIG. 1 illustrates a flowchart for user registration. In accordance with the system of the present disclosure, the system comprises a user interface that enables the user(s) to register with a database vault 102, who is likely to utilize the system of the present disclosure to carry out his/her transactions securely. In an embodiment of the system of the present disclosure, the aforementioned user interface is a web browser based application. The system prompts the user to enter his/her login details 104 displayed on a user interface device such as a computer, a laptop, an iPad, a tablet and the like. The system includes a logging module configured to elicit login credentials from users 108. The logging module, after acquiring the user's login credentials, verifies the login details with those stored in a backend repository or the database vault. Once the user's login credentials are verified by the back end repository, the system prompts the user with a downloadable link 112a, 114a. The user can be registered with system of the present disclosure as a customer or a merchant 112, 114. The user's credentials as well as other related information such as user's financial account details and the like are stored in the database vault of the system.

In accordance with present disclosure, in an event, if the user is registering as a customer with the system, he/she has to provide the device identification indicia of his/her user interface device along with the credentials. Typically, the aforementioned step is to register a customer interface device, which will be used by the customer to carry out his/her transactions. The customer interface device is an Internet enabled device.

Typically, subsequent to successful registrations of the user 110, the user receives identification (ID) such as a customer ID, in an event, if the registered user is the customer and a merchant ID, in an event, if the registered user is the merchant as an email or a message or SMS or call and the like. Typically, the customer ID serves as a password to enter into the customer interface mobile application. The customer ID and/or merchant ID used hereinafter in the specification refers to, but is not limited to, an alphanumeric combination, a barcode, and a Quick Response (QR) code. In accordance with the present disclosure, the merchant registered with the system, enabled to prominently display the merchant ID visible to the customers, wherein the merchant is at least selected from a group consisting of an e-commerce website(s), a merchant POS, and an ATM of a financial institution. The merchant ID ensures the occurrence of valid transaction(s) at the merchant(s) interface, authorized by the system of the present disclosure.

In accordance with the system of the present disclosure, the database vault as disclosed, a highly secure database, stores the registered user credentials and communicates with a financial institution or an authorizing interface or a financial account such as a payment network or a third party EFT switch and the like for validating the transactions. The data or information stored in the database vault is secure and is not shared with any of the merchant(s) whether registered/un-registered with the system of the present disclosure.

In accordance with the present disclosure, an OTP generating means generates the OTP and transmits the OTP to the corresponding customer on his/her customer interface device.

In accordance with the system of the present disclosure, the customer interface device application enables the users, who are registered with the system as customers to download the handheld device executable application on his/her respective handheld devices registered with the system from the web based frontend. The aforementioned handheld device application is protected by a password.

In accordance with the system of the present disclosure, the users can use the system without downloading the handheld device executable application on his/her respective handheld devices. The users can be customers or merchants. Each of the users has to register with his/her financial institution, where a user's financial account is linked with a registered mobile number. In one embodiment, an OTP is sent to the registered mobile number of the user. In another embodiment, the each of the users receives an OTP by dialing a toll free number associated with the financial institution, from his/her registered mobile number. This OTP received by each of the user is valid for a predetermined time or till the next immediate transaction.

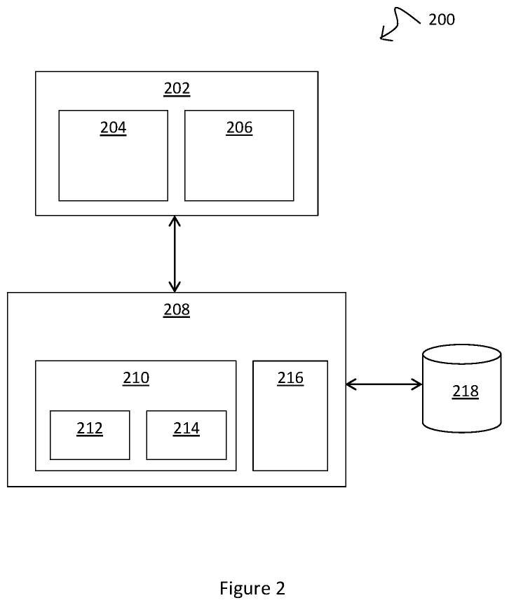

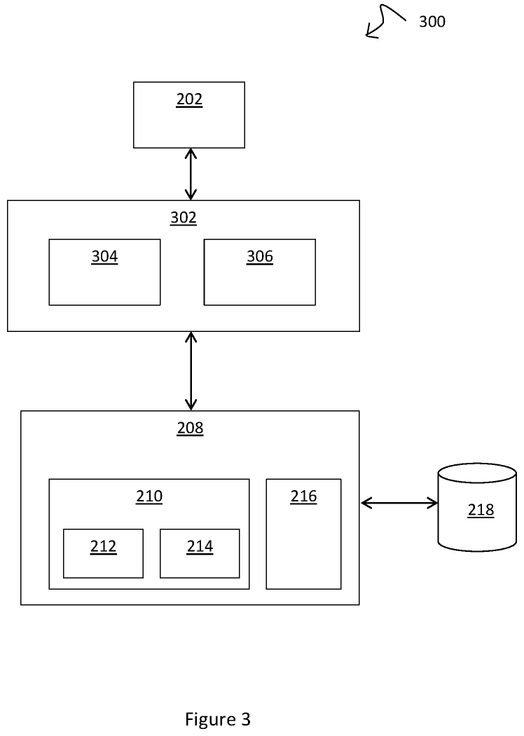

A first vine and a second vine of the system of the present disclosure for carrying out a cardless and a cashless transaction will be described herein below with reference to FIGS. 2 to 3.

Referring to the accompanying drawing, FIG. 2 illustrates a schematic diagram of the first vine of the computer implemented system 200 for performing the cardless and cashless transactions. The system 200 includes a customer interface device 202, a transaction server 210 of a financial institution 208, and a database vault 218. The customer interface device 202 includes a logging module 204 and a first communication module 206. The financial institution 208 includes a One-Time-Password (OTP) generating means 212, a second communication module 214, and an authorizing interface 216.

The customer visits a merchant and proceeds for a payment by initiating the first vine of a transaction from the customer interface device 202 by using the logging module 204 of the customer interface device 202. The customer first provides the customer ID at the logging module 204. In an embodiment, the logging module 204 communicates the transaction server 210 to verify the login credentials. In an embodiment, the transaction server 210 cooperates with the database vault 218 to verify the credentials.

Once the customer ID is successfully verified, the user is successfully logged in. In an embodiment, the customer after successful verification makes a call to a toll free number of the financial institution 208 via the first communication module 206 and initiates an OTP generation request. In another embodiment, the customer or user enters at least one of a merchant ID and a transaction amount on the call over a first channel. In a further embodiment, the first channel can be a digital subscriber line, telephone circuit, or any telecommunication network. In yet another embodiment, the second communication module 214 of the transaction server 210 of the financial institution 208 receives the customer's device information on the call. In an implementation, the customer device 202 may receive the OTP through an SMS, text message, push notification and the like.

The transaction server 210 at a side of the financial institution 208 now generates a time bound OTP in response to the call. In an embodiment, the time bound OTP includes encoded information. In another embodiment, the encoded information includes the customer ID, the merchant ID, the transaction amount, a time stamp and any combination thereof. In an implementation, the OTP generating means 212 of the transaction server 210 generates the time bound OTP. In yet another embodiment, the OTP generating means 212 cooperates with the database vault 218 to extract information corresponding to the customer ID and merchant ID, such as a customer financial account, a merchant financial account, customer contact details, merchant contact details, device identification indicia of the customer interface device 202 and the like. In one embodiment, the OTP can be an alphanumeric combination, QR code and the like. In another embodiment, the generated OTP is also stored in the database vault 218 for a pre-determined time.

The transaction server 210 now transmits the time bound OTP over the first channel via a second communication module 214 to the first communication module 206 of the customer interface device 202.

In accordance with the system 200 of the present disclosure, the customer proceeds for a payment process by initiating the first vine of the transaction from his/her customer interface device 202 without using the customer interface device application by making a call to the toll free number of the financial institution 208. In an embodiment, the customer makes call to the toll free number by using the customer interface device 202 and complete the payment process to the merchant. For example, the customer by using the customer interface device 202, make the call to the toll number and enter merchant ID of the merchant and amount to be paid. Further, the customer may only enter amount of the transaction and accordingly the OTP is generated. Such an OTP can be verbally shared with the merchant, wherein merchant invokes the second vine in the similar way as will be described in FIG. 3.

Referring to the accompanying drawing, FIG. 3 illustrates a schematic of the second vine of the computer implemented system 300 for performing the cardless and cashless transactions. The system 300 includes the role of a merchant interface device 302, the authorizing interface 216, the transaction server 210 and the database vault 218. The customer interface device 202 communicates the OTP received in the first vine to the merchant interface device 302, wherein the first vine is in accordance with the description as described in FIG. 2. In an embodiment, the customer after receiving the time bound OTP may verbally share the same with the merchant and the merchant may invoke the second vine in the same way as described herein below.

The merchant utilizing the merchant interface device 302 transmits the OTP over a second channel, via a third communication module 304, received from the customer interface device 202, to the transaction server 210. The authorizing interface 216 of the transaction server 210 receives the OTP via the second communication module 214. Further, a decrypting module (not shown in the diagram) of the authorizing interface 216 is enabled to decrypt the encoded information contained within the OTP. In an embodiment, the decrypting module implements decryption techniques on the OTP and decrypts the information which includes, but is not limited to, customer ID, the merchant ID, the transaction amount, a time stamp and any combination thereof. In an embodiment, the transaction server 210 decrypts aforesaid in cooperation with the database vault 218. In an embodiment, the authorizing interface 216 first validates the OTP by checking whether the OTP received at the merchant interface device 302 is within a prescribed time limit. Else, the OTP is dropped or discarded by the transaction server 210 and the merchant is informed regarding the failure of the transaction. In another embodiment, the authorizing interface 216 cooperates with the database 218 to check the time stamp.

Further, subsequent to a successful validation of the time limit of the OTP, the authorizing interface 216 validates rest of the decrypted information by cooperating with the database vault 218. For example, from a repository of registered users and merchants, the account information is validated such as account details, device indicia and the like.

The authorizing interface 216 on successful validation debits the transaction amount from the customer financial account and credits the transaction amount in the merchant financial account and confirms the merchant and the customer.

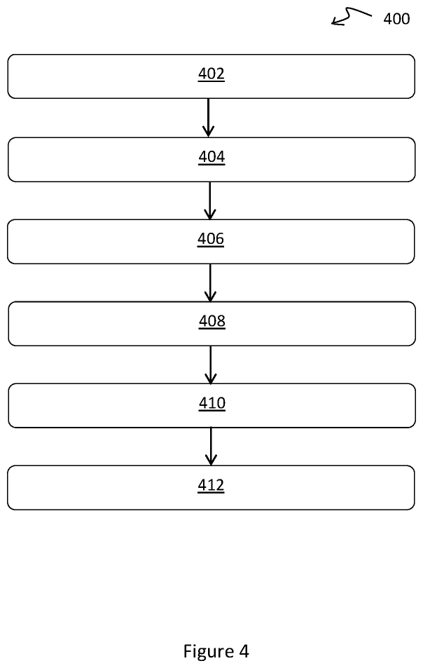

Referring to the accompanying drawing, FIG. 4 illustrates method steps of performing cardless and cashless transactions, in accordance with the present disclosure.

In step 402, a customer initiates a first vine when he visits a merchant and initiates payment process through a customer interface device 202. In an embodiment, a customer ID is entered in a logging module 204. A transaction server 210 in cooperation with a database vault 218 validates the customer ID.

In step 404, a toll free number of a financial institution is called over a first channel using the customer interface device 202 and at least one of a merchant ID and a transaction amount is provided. In an embodiment, an OTP generation is requested over the first channel.

In step 406, a time bound OTP is generated, in response to the call over the first channel. The time bound OTP includes encoded information such as the customer ID, the merchant ID, the transaction amount, and a time stamp. In an embodiment, the time bound OTP is generated by an OTP generation means 212 of the transaction server 210. In another embodiment, the details of the customer interface device 202, such as device identification number, are received by the transaction server 210 on the call over the first channel. The generated time bound OTP is communicated to a first communication module 206 of the customer interface device 202 by a second communication module 214 of the transaction server 210.

In step 408, the time bound OTP is communicated via the first communication module 206 of the customer interface device 202 to a third communication module 304 of a merchant interface device 302. In an embodiment, the third communication module 304 of the merchant interface device 302 receives the time bound OTP.

In step 410, the time bound OTP is communicated via the third communication module 304 of the merchant interface device 302 to the second communication module 214 of the transaction server 210. The authorization interface 216 decrypts the encoded information and then extracts the details corresponding to the encoded information in cooperation with the database vault 218. In a further embodiment, the aforesaid information includes, but not limited to, the merchant ID, the customer ID, the time stamp, the transaction amount. In a still further embodiment, the authorization interface 216 checks the timestamp contained within the OTP immediately after the decryption to ensure the integrity and confidentiality of the OTP. In yet another embodiment, rest of the details contained within OTP are validated from the database vault 218 such as the customer and merchant account details, necessary balance required to complete transaction and the like.

In step 412, a desired amount is credited into merchant's account from customer's account on successful authorization of the decrypted information of the time bound OTP. In an embodiment, on completion of validation of the details of the customer's account and merchant's account the authorization interface credits the merchant's account and debits customer's account.

In accordance with the present disclosure, subsequent to successful completion of the transaction through the first vine and the second vine, the system sends a message or makes a call to the customer interface device 202 and to the merchant interface device for the successful completion of the transaction.

In accordance with the present disclosure, all the transaction steps are controlled by customer for making payments. For example, if there is loss of customer interface device which may entail information related to the customer's financial account(s).

However, monetary transactions cannot be performed using the lost handheld device of the customer by any third person, as the system is provided with a mechanism (not shown is figure) for receiving and authenticating user ID proof or photograph in electronic format to perform transaction.

In accordance with the present disclosure, the time bound OTP generated by the server and transmitted to the user, it can be used for a single instance only, if used for two or more instances, the system will generate error message and inform the customer and/or merchant that the time bound OTP is already used. After the expiry of the prescribed time limit of the time bound OTP, the OTP cannot be used for completing the transaction.

In accordance with the present disclosure, typically the system determines the available balance in customer's financial account in the event user selects to withdraw cash from the ATM or purchase product/s from an e-commerce website or purchase product/s from a merchant Point-of-Sale (POS). If the required transaction amount is not present for the completing the transaction initiated by the user in the user's financial account, the server sends an error signal to the user's handheld device in the form of a message or an e-mail and the like.

In accordance with the present disclosure is to provide a secure system incorporated with a biometric feature (not shown in figures). For performing high value transactions the system will ask the user to provide a biometric parameter such as a thumb impression, a voice recognition pattern, a face recognition pattern, a palm recognition pattern and the like before debiting money from the user's financial account(s). The aforementioned feature eliminates occurrence of any an unauthorized transaction(s).

In accordance with the present disclosure, the system can be integrated with payment network's authentication application for customer enhancing securing measures. In accordance with the present disclosure, once the OTP is received and submitted by the merchant into his/her device for accepting or declining the transaction, another layer of authentication protected by a password can be incorporated to perform high valued transactions from being intercepted.

### TECHNICAL ADVANCEMENTS AND ECONOMIC SIGNIFICANCE

The present disclosure described herein above has several technical advantages including, but is not limited to, the realization of a computer implemented system and method for securing cashless and cardless transactions that:
does not reveal user's identity;
withdraw cash from ATM machine without using a financial card;
enables a user to deposit cash into an ATM machine;
does not require user signatures for performing monetary transactions;
facilitates biometric features for performing high value transactions;
is reliable;
is cost effective;
provides less possibility to misuse the transaction details; prevents the occurrence of fraud transactions in real-time; and
is user friendly.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results. The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

1. A computer implemented system (200, 300) for a cardless and cashless transaction, said system (200, 300) comprising:
a database vault (218) configured to store registered users details and registered merchants details;
a customer interface device (202) comprising:
a logging module (204) configured to receive a customer ID and check a registration status in cooperation with said database vault (218), wherein the customer interface device (202) is configured to initiate a first vine of said transaction by making a call on a toll free number of a financial institution (208) over a first channel via a first communication module (206) and providing at least one of a merchant ID and a transaction amount;
a transaction server (210) at a side of said financial institution (208) configured to generate an OTP in response to said call, wherein said transaction server (210) includes an OTP generating means (212) to generate a time bound OTP and communicates the same over said first channel via a second communication module (214) to said customer interface device (202), wherein said time bound OTP includes encoded information; and
a merchant device (302) configured to receive said time bound OTP over a second channel via a third communication module (304) from said customer interface device (202), wherein said merchant device (302) transmits said time bound OTP to an authorizing interface (216) of said transaction server (210) for authorizing said transaction, wherein said merchant device (302) is configured to initiate a second vine of said transaction.

2. The computer implemented system (200, 300) as claimed in claim 1, wherein said authorizing interface (216) is configured to perform at least the following steps:
decrypt said time bound OTP;
validate said time bound OTP by verifying said encoded information, wherein the authorizing interface (216) cooperates with said customer interface device (202) to validate said time bound OTP; and
at least one of completing the transaction and rejecting the transaction based on a validation of said time bound OTP.

3. The computer implemented system (200, 300) as claimed in claim 1, wherein said first communication channel includes a toll free telephone line.

4. The computer implemented system (200, 300) as claimed in claim 1, wherein said transaction server (210) cooperates with said database vault (218) to validate received customer ID and extract details thereof.

5. The computer implemented system (200, 300) as claimed in claim 1, wherein said encoded information is selected from group consisting of said customer ID, said merchant ID, said transaction amount, a time stamp and any combination thereof.

6. The computer implemented system (200, 300) as claimed in claim 1, wherein said transaction server (210) identifies indicia of said customer interface device (202), on said call.

7. The computer implemented system (200, 300) as claimed in claim 1, wherein said database vault (218) stores time bound OTP for a pre-defined time for validation purposes.

8. A computer implemented method (400) for a cardless and cashless transaction, said method (400) comprising steps of:
initiating a first vine (402) of a transaction through a customer interface device (202) by providing a customer ID;
calling (404) a transaction server (210) of a financial institution (208) using said customer interface device (202) over a first channel and providing at least one of a merchant ID and a transaction amount;
generating a time bound OTP (406) in response to said call and receiving said time bound OTP over said first channel, wherein said time bound OTP includes encoded information;
communicating (408) said time bound OTP to a merchant interface device (302) over a second channel;
transmitting (410) said time bound OTP to said transaction server (210) for authorizing said transaction, wherein said transaction server (210) cooperates with said customer interface device (202) for said authorizing; and
at least one of completing the transaction and rejecting the transaction (412) based on said authorizing.

9. The computer implemented method (400) as claimed in claim 8, wherein said authorizing of said transmitting (410) includes decrypting said encoded information contained within said time bound OTP.

10. The computer implemented method (400) as claimed in claim 9, wherein said decrypting includes checking a timestamp contained within said encoded information to ensure the integrity and confidentiality of said time bound OTP.

11. The computer implemented method (200) as claimed in claim 8, wherein said generating a time bound OTP (406) includes storing said time bound OTP in a database vault (218) for a pre-defined time for said authorizing purposes.
